(19) United States
(12) Patent Application Publication
(10) Pub. No.: US 2024/0043736 A1
(43) Pub. Date: Feb. 8, 2024

(54) ANTI-SLOUGHING DRILLING FLUID AND USE THEREOF

(71) Applicant: Southwest Petroleum University, Chengdu City (CN)

(72) Inventors: Yang BAI, Chengdu City (CN); Daoxiong LI, Chengdu City (CN); Ren WANG, Beijing (CN); Gang XIE, Chengdu City (CN); Danchao HUANG, Chengdu City (CN); Wenzhe LI, Chengdu (CN); Feng DAI, Chengdu (CN); Jintang WANG, Chengdu City (CN); Jing ZHANG, Chengdu City (CN); Jinsheng SUN, Chengdu City (CN)

(73) Assignee: Southwest Petroleum University, Chengdu City (CN)

(21) Appl. No.: 18/175,101

(22) Filed: Feb. 27, 2023

(30) Foreign Application Priority Data
Aug. 3, 2022 (CN) 202210928496.3

(51) Int. Cl. C09K 8/42

(52) U.S. Cl. CPC C09K 8/426; C09K 2208/10; C09K 2208/12

(57) ABSTRACT

The present disclosure relates to the technical field of oilfield chemistry, and discloses an anti-sloughing drilling fluid and a use thereof.

### FIELD

The present disclosure relates to the technical field of oil field chemistry, and particularly to an anti-sloughing drilling fluid and an use thereof.

### BACKGROUND

The collapsed horizon of a stratum have numerous cracks during the process of drilling horizontal well; the drilling fluid will rapidly enter the stratum along the cracks while drilling the stratum, such that the mud shale hydrates, swells and disperses when contacting with water, resulting in the troubles of horizontal well such as falling of blocks, and instability of the borehole wall during the process of drilling well and operation, thereby seriously affecting quality and progress of well drilling. The collapse of horizontal well and instability of borehole wall mainly occur in hard and brittle mud shale stratum containing cracks, this kind of stratum mostly presents stratifications and micro-fractures which are close or open and have strong capillary force, and the drilling fluid can easily invade under the positive pressure differential and capillary pressure, it results in the fracturing of the mud shale along the fracture plane or stratification surface, and the longitudinal and horizontal development along the fracture plane continuously, thereby magnifying the borehole wall instability.

The oil-based drilling fluids offer advantages over the water-based drilling fluids in the aspects such as high temperature resistance, salt intrusion resistance, facilitating stability of the borehole wall, and causing less damage to the oil and gas reservoir. In order to further address the problem of borehole wall destabilization and collapse, the oil-based drilling fluids are required to effectively plug the pores and cracks in the borehole wall stratum with various sizes, and have small filtrate loss and desirable function of strengthening the borehole wall. However, due to the restrained properties of plugging materials in the ingredients, the existing oil-based drilling fluids do not perform well for plugging the minimum level micro-nanometer pores and cracks in the stratum (with a size distribution of 1-10 nm), and can hardly form a dense mud cake and thereby perform the desired plugging effect.

### SUMMARY

The present disclosure intends to solve the problems in the art concerning that the plugging effect of the oil-based drilling fluids is undesirable, the borehole wall stability and anti-sloughing requirements during the well drilling operation cannot be effectively satisfied, and provides an anti-sloughing drilling fluid and a use.

In order to achieve the above object, a first aspect of the present disclosure provides an anti-sloughing drilling fluid comprising the following ingredients: a base oil, an organic clay, an emulsifier, a plugging anti-sloughing agent, a filtrate reducer, an inhibitor, a pH regulator, a weighting agent, and a flow pattern regulator;
wherein the plugging anti-sloughing agent comprises inorganic rigid particles and nanographene; the inorganic rigid particles have an average particle size of 0.6-50 μm, and the nanographene has an average particle size of 30-300 nm.

A second aspect of the present disclosure provides a use of the anti-sloughing drilling fluid of the first aspect in oil and gas drilling.

Due to the above technical schemes, the oil-based drilling fluid provided by the present disclosure use the inorganic rigid plugging materials to compound with nanographene to prepare the plugging anti-sloughing agent, wherein the ingredients of the plugging anti-sloughing agent have a reasonable particle size grading, and the particles are pressed against each other, tightly coupled and alternately plugged, are capable of effectively plugging pore throats and cracks of various sizes in the stratum, and facilitating the formation of a dense and tensile mud cake, and preventing the penetration of permeable pores and cracks by the filtrate of drilling fluid, wherein the anti-sloughing drilling fluid is subjected to a high-temperature and high-pressure filtrate loss amount test under the conditions consisting of a temperature of 120° C. and a pressure differential of 3.5 MPa, the filtrate loss amount is less than or equal to 6 mL, the mud cake obtained after the test has a thickness less than or equal to 1.8 mm, and the mud cake has a lubrication coefficient less than or equal to 0.09, and thus the oil-based drilling fluid is effective in stabilizing borehole wall and preventing the collapse.

### DETAILED DESCRPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point value of the various ranges, and the individual point values may be combined with one another to produce one or more new numerical ranges, which should be deemed have been specifically disclosed herein.

The specific embodiments of the present disclosure are described in detail below. It should be comprehended that the specific embodiments described herein merely serve to illustrate and explain the present disclosure, instead of imposing a limitation thereto.

A first aspect the present disclosure provides an anti-sloughing drilling fluid comprising the following ingredients: a base oil, an organic clay, an emulsifier, a plugging anti-sloughing agent, a filtrate reducer, an inhibitor, a pH regulator, a weighting agent, and a flow pattern regulator;
wherein the plugging anti-sloughing agent comprises inorganic rigid particles and nanographene; the inorganic rigid particles have an average particle size of 0.6-50 μm, and the nanographene has an average particle size of 30-300 nm.

According to the present disclosure, the plugging anti-sloughing agent in the anti-sloughing drilling fluid is prepared by compounding the inorganic rigid particles and nanographene with different particle sizes. The plugging anti-sloughing agent comprises both micro-scale plugging material particles and nano-scale plugging material particles.

According to the present disclosure, among the ingredients of the plugging anti-sloughing agent, the inorganic rigid particles further comprise: inorganic rigid particles I, inorganic rigid particles II and inorganic rigid particles III;

Wherein the inorganic rigid particles I have an average particle size of 0.6-8 μm, the inorganic rigid particles II have an average particle size of 8-20 μm, and the inorganic rigid particles III have an average particle size of 20-50 μm.

According to the present disclosure, given that the inorganic rigid particles I, inorganic rigid particles II and inorganic rigid particles III contained in the plugging anti-sloughing agent fall into the aforementioned particle size definition scope, it is preferable that the inorganic rigid particles I have an average particle size of 1-4 μm, the inorganic rigid particles II have an average particle size of 10-15 μm, and the inorganic rigid particles III have an average particle size of 25-40 μm.

According to the present disclosure, among the ingredients of the plugging anti-sloughing agent, it is preferable that the nanographene has an average particle size of 60-250 nm.

In the present disclosure, the average particle size refers to the median particle diameter (D50). The average particle size can be measured by using a laser particle size analyzer (wet process).

According to the present disclosure, among the ingredients of the plugging anti-sloughing agent, the inorganic rigid particles I, inorganic rigid particles II, inorganic rigid particles III and nanographene satisfy the above-mentioned range of particle size definition, furthermore, the weight of each ingredient satisfy that a weight ratio of the inorganic rigid particles I:inorganic rigid particles II:inorganic rigid particles III:nanographene is (1.5-4.5):(1.5-4.5):(1.5-4.5):1.

According to a preferred embodiment of the present disclosure, a weight ratio of the inorganic rigid particles I:inorganic rigid particles II:inorganic rigid particles III:nanographene is preferably (2-4):(2-4):(2-4):1.

According to a further preferred embodiment of the present disclosure, a weight ratio of the inorganic rigid particles I:inorganic rigid particles II:inorganic rigid particles III:nanographene is 3:3:3:1.

According to the present disclosure, the plugging anti-sloughing agent in the anti-sloughing drilling fluid comprises inorganic rigid particles and nanographene which are compounded in a specific weight ratio, and satisfy a specific particle size grading relationship, thereby providing the excellent plugging effect. When drilling a stratum which is prone to destabilize or collapse, the inorganic rigid particles III of the anti-sloughing drilling fluid having a relatively large average particle size are first bridged to reduce the size of rock pores and cracks; the inorganic rigid particles II having a relatively small average particle size and the inorganic rigid particles I having a smaller average particle size are then filled sequentially to further reduce the size of the pores and cracks; the nanographene having the smallest average particle size finally plugs the micro-scale and nanometer-sized cracks. In this manner, the anti-sloughing drilling fluid can effectively plug pores and cracks having various sizes in the borehole wall and exhibits excellent properties of filtrate loss and borehole wall formation, the drilling fluid can form a thin and dense mud cake on the borehole wall, strengthen the borehole wall, reduce invasion of solid phases and liquid phases of the drilling fluid into the stratum and the damage to the oil and gas reservoir, thereby fulfill the purpose of stabilizing the borehole wall and preventing the collapse.

According to the present disclosure, the inorganic rigid particles I are at least one selected from the group consisting of calcium carbonate, silica and titanium dioxide.

According to the present disclosure, the inorganic rigid particles II are at least one selected from the group consisting of calcium carbonate, silica and titanium dioxide.

According to the present disclosure, the inorganic rigid particles III are at least one selected from the group consisting of calcium carbonate, silica and titanium dioxide.

According to the present disclosure, the substances selected for each of the inorganic rigid particles I, the inorganic rigid particles II and the inorganic rigid particles III may be the same or different; preferably different; the substances may comprise a circumstance that any two kind of the particles are the same substance, but are different substances from the other particles, for example, the inorganic rigid particles I are calcium carbonate, both the inorganic rigid particles II and the inorganic rigid particles III are silica, or the three kinds of particles are different substances.

According to a preferred embodiment of the present disclosure, the inorganic rigid particles I are calcium carbonate, which have an average particle size of 1-4 μm, the inorganic rigid particles II are silica, which have an average particle size of 10-15 μm, and the inorganic rigid particles III are titanium dioxide, which have an average particle size of 25-40 μm.

In the present disclosure, the inorganic rigid particles I, the inorganic rigid particles II and the inorganic rigid particles III are commercially available from the conventional channel, only if the particles meet the aforementioned requirements on the material and average particle size.

The present disclosure has a relatively broad definition scope in regard to the nanographene, as long as the above-mentioned definition of the particle size ranges can be satisfied. Preferably, the nanographene can be produced with the following preparation method comprising the following steps:
(1) mixing phthalic acid, urea, ceria and ammonium heptamolybdate tetrahydrate to obtain a mixture-A;
(2) melting the mixture-A to obtain a product-B;
(3) subjecting the product-B to a first reaction to obtain a product-C;
(4) subjecting graphite oxide and the product-C to a second reaction to prepare nanographene.

According to the present disclosure, a feedstock weight ratio of phthalic acid:urea:ceria:ammonium heptamolybdate tetrahydrate in step (1) is (6-7):(16-20):(6-7):1, preferably (6.3-6.8): (17-18):(6.4-6.8):1.

According to the present disclosure, the mixing in step (1) may be performed in a conventional manner, as long as sufficient intermixing of the above-mentioned raw materials is achieved to obtain the uniform mixture-A. Preferably, the mixing may be performed by means of ball milling, for example, feeding the raw materials according to the above-mentioned weight ratio into a ball mill and carrying out the ball-milling by using the conventional operating parameters, the ball-milling conditions preferably comprising a rotation speed of 300-500 rpm and a time of 3-6 h.

According to the present disclosure, the mixture-A in step (2) is heated to 110-130° C. and then kept the temperature for 10-20 min, when the mixture-A is completely converted from a solid state to a molten state, the product-B is obtained.

According to the present disclosure, the product-B in a molten state in the step (3) voluntarily reacts under a certain temperature, and the product-C obtained after cooling is a phthalocyanine compound.

According to the present disclosure, the conditions of the first reaction in step (3) comprise: a temperature of 60-90° C., preferably 70-80° C.; and a time of 5-10 min, preferably 6-8 min.

According to the present disclosure, the product-C in step (4) acts as an initiator and initiates the pyrolytic reaction of graphite oxide to obtain nanographene. In order to facilitate separation of the initiator from the nanographene product after the reaction is completed, the product-C is preferably fed in a block form.

According to the present disclosure, it is preferable that a weight ratio of the product-C:graphite oxide in step (4) is (16-18):1.

According to the present disclosure, the conditions of the second reaction in step (4) comprise: a temperature of 300-800° C., preferably 600-800° C.; and a time of 16-24 h, preferably 18-24 h.

According to the present disclosure, the second reaction in step (4) is preferably carried out under an inert atmosphere, and the inert protective gas in use may be nitrogen, helium, argon and the like, preferably argon.

The method uses oxidative cracking process to prepare nanographene with an average particle size controlled within a range of 30-300 nm. The phthalocyanine compound is used as a catalyst during the preparation process, its ingredients do not enter the product nanographene. Compared to the conventional graphene products, the nanographene synthesized with the method is essentially free from impurity. At the same time, the synthesized nanographene has a desirable dispersibility in both an aqueous phase and an oil phase, and is not prone to agglomerate, thereby facilitate the production of better effect of plugging microcracks.

According to the present disclosure, the ingredients of the anti-sloughing drilling fluid satisfy the following conditions: 2-9 parts by weight of the organic clay, 1-9 parts by weight of the emulsifier, 1-9 parts by weight of the plugging anti-sloughing agent, 2-12 parts by weight of the filtrate reducer, 10-30 parts by weight of the inhibitor, 2-9 parts by weight of the pH regulator, 250-300 parts by weight of the weighting agent, and 1-5 parts by weight of the flow pattern regulator, based on 100 parts by weight of base oil.

Based on the fact that the anti-sloughing drilling fluid may satisfy the above ingredients, preferably, the ingredients of the drilling fluid satisfy the following conditions: 3-8 parts by weight of the organic clay, 2-8 parts by weight of the emulsifier, 3-7 parts by weight of the plugging anti-sloughing agent, 4-10 parts by weight of the filtrate reducer, 15-25 parts by weight of the inhibitor, 4-8 parts by weight of the pH regulator, 260-290 parts by weight of the weighting agent, and 2-4 parts by weight of the flow pattern regulator, based on 100 parts by weight of base oil.

According to the present disclosure, the base oil may be the conventional base oil used in the oil-based drilling fluids in the technical field, the present disclosure has a broadly defined scope of the base oil. The base oil is preferably white oil and/or diesel oil, further preferably white oil, more preferably 3# white oil and/or 5# white oil. In the present disclosure, both the white oil and the diesel oil may be conventional and commercially available brand products, the present disclosure does not impose specific limitation thereto.

According to the present disclosure, the organic clay is an oleophilic clay produced from an interaction of a hydrophilic bentonite with an alkyl quaternary ammonium salt cationic surfactant, wherein the hydrophilic bentonite is preferably sodium bentonite; the long chain alkyl group in the alkyl quaternary ammonium salt cationic surfactant preferably contains 12-30 carbon atoms, further preferably 18-25 carbon atoms, more preferably 20-22 carbon atoms. In the present disclosure, the organic clay may be voluntarily produced with a conventional method in the art, or may be a conventional and commercially available brand product, which is not specifically defined in the present disclosure.

According to present disclosure, the emulsifier is at least one selected from the group consisting of calcium naphthenate, oleic acid, naphthenic acid amides, calcium alkylbenzenesulfonate, and Span series emulsifier.

In the present disclosure, a formula of the calcium naphthenate preferably has 10-14 carbon atoms, further preferably 11-13 carbon atoms; a formula of the naphthenic acid amide preferably has 12-18 carbon atoms, further preferably 14-16 carbon atoms; a formula of the calcium alkylbenzenesulfonate preferably has 12-18 carbon atoms, further preferably 14-16 carbon atoms; the Span series emulsifier is preferably at least one selected from the group consisting of Span 80, Span 70 and Span 60, and further preferably Span 80. In the present disclosure, the emulsifier may be a conventional and commercially available brand product, the present disclosure is not particularly limited thereto.

According to the present disclosure, the filtrate reducer may be the conventional filtrate reducer used for preparing oil-based drilling fluids in the technical field, the present disclosure imposes a broadly defined scope thereto. The filtrate reducer is preferably at least one selected from the group consisting of oxidized asphalt, sodium carboxymethyl cellulose, humic acid and lignite lye, further preferably oxidized asphalt. In the present disclosure, the filtrate reducer may be voluntarily prepared with a method conventionally used in the art, or may be a conventional and commercially available brand product, the present disclosure does not impose a specific limitation thereto.

According to the present disclosure, the inhibitor may be the conventional inhibitor used for preparing oil-based drilling fluids in the technical field, the present disclosure imposes a broadly defined scope thereto. Preferably, the inhibitor is selected from a calcium chloride aqueous solution and/or a potassium chloride aqueous solution.

According to the present disclosure, the pH regulator may be the conventional pH regulator used for preparing oil-based drilling fluids in the technical field, the present disclosure imposes a broadly defined scope thereto. Preferably, the pH regulator is selected from calcium oxide and/or sodium carbonate, further preferably calcium oxide.

According to the present disclosure, the weighting agent may be the conventional weighting agent used for preparing oil-based drilling fluids in the technical field, the present disclosure imposes a broadly defined scope thereto. Preferably, the weighting agent is at least one selected from the group consisting of API barite, ultrafine barium sulfate, magnetite powder, ilmenite powder and trimanganese tetroxide, further preferably API barite.

According to the present disclosure, the flow pattern regulator may be the conventional flow pattern regulator used for preparing oil-based drilling fluids in the technical field, the present disclosure imposes a broadly defined scope thereto. Preferably, the flow pattern regulator is at least one selected from a group consisting of guar gum, xanthan gum and a polymer composed of β-1,4-glycosidically linked glucose monomers, and further preferably a polymer composed of β-1,4-glycosidically linked glucose monomers. In the present disclosure, the flow pattern regulator may be a conventional and commercially available brand product, the present disclosure is not particularly limited thereto.

According to the present disclosure, the anti-sloughing drilling fluid is subjected to a high-temperature and high-pressure filtrate loss amount test under the conditions consisting of a temperature of 120° C. and a pressure differential of 3.5 MPa, the filtrate loss is less than or equal to 6 mL, a mud cake obtained after the test has a thickness less than or equal to 1.8 mm, and the mud cake has a lubrication coefficient less than or equal to 0.09.

The anti-sloughing drilling fluid as provided herein can be produced by thoroughly mixing the ingredients using methods conventionally found in the art for preparing oil-based drilling fluids.

The anti-sloughing drilling fluid provided by the present disclosure includes a composite plugging material comprising inorganic rigid particles and nanographene, wherein the inorganic rigid particles and nanographene are compounded according to a specific weight ratio and satisfy a specific particle size grading relationship, thus the drilling fluid is capable of effectively plugging pore throats and cracks having various sizes in a stratum and having excellent properties of filtrate loss and borehole wall formation, thereby obtaining an excellent effects of stabilizing the borehole wall and preventing collapse.

A second aspect of the present disclosure provides a use of an anti-sloughing drilling fluid according to the first aspect in oil and gas drilling.

The present disclosure will be described in detail below with reference to Examples. Among the following Examples, Comparative Examples and Test Examples,

Base oil: 3# white oil, purchased from Shanghai Yuanye Bio-Technology Co., Ltd.;

Organic clay: brand No. HW Ge1-3, purchased from the West China Oil Wei Technology Co., Ltd. in Chengdu, Sichuan Province;

Emulsifier: Span 80, an ordinary commercially available product;

Filtrate reducer: oxidized asphalt, brand No. Trol-101, purchased from the West China Oil Wei Technology Co., Ltd. in Chengdu, Sichuan Province;

Inhibitor: calcium chloride aqueous solution (with a concentration of 25 wt %), wherein the calcium chloride was purchased from Sigma-Aldrich (Shanghai) trade Co., Ltd.;

pH regulator: calcium oxide, purchased from the West China Oil Wei Technology Co., Ltd. in Chengdu, Sichuan Province;

Weighting agent: API barite, an ordinary commercially available product;

Flow pattern regulator: a polymer composed of β-1,4-glycosidically linked glucose monomers, brand No. ML-CSON, purchased from the West China Oil Wei Technology Co., Ltd. in Chengdu, Sichuan Province;

Plugging anti-sloughing agent-M1: in the plugging anti-sloughing agent-M1, the weight ratio of inorganic rigid particles I:inorganic rigid particles II:inorganic rigid particles III:nanographene-a was 3:3:3:1;

Plugging anti-sloughing agent-M2: in the plugging anti-sloughing agent-M2, the weight ratio of inorganic rigid particles I:inorganic rigid particles II:inorganic rigid particles III:nanographene-a was 2:2:2:1;

Plugging anti-sloughing agent-M3: in the plugging anti-sloughing agent-M3, the weight ratio of inorganic rigid particles I:inorganic rigid particles II:inorganic rigid particles III:nanographene-a was 4.5:4.5:4.5:1;

Plugging anti-sloughing agent-M4: in the plugging anti-sloughing agent-M4, the weight ratio of inorganic rigid particles I:inorganic rigid particles II:inorganic rigid particles III:nanographene-b was 4.5:4.5:4.5:1;

Plugging anti-sloughing agent-M5: in the plugging anti-sloughing agent-M5, the weight ratio of inorganic rigid particles I:inorganic rigid particles II′:inorganic rigid particles III:nanographene-a was 4.5:4.5:4.5:1;

Plugging anti-sloughing agent-DM1: in the plugging anti-sloughing agent-DM1, the weight ratio of inorganic rigid particles I:inorganic rigid particles II:inorganic rigid particles III:nanographene-a was 5:5:5:1;

Plugging anti-sloughing agent-DM2: in the plugging anti-sloughing agent-DM2, the weight ratio of inorganic rigid particles I:inorganic rigid particles II:inorganic rigid particles III:nanographene-a was 1:1:1:1;
wherein,
inorganic rigid particles I: calcium carbonate particles with an average particle size of 2 μm;
inorganic rigid particles II: silica particles with an average particle size of 12 μm;
inorganic rigid particles III: titanium dioxide particles with an average particle size of 30 μm;
inorganic rigid particles II′: calcium carbonate particles with an average particle size of 12 μm; inorganic rigid particles III′: calcium carbonate particles with an average particle size of 30 μm;
nanographene-a: was obtained through a voluntary production process, the preparation process was as follows:

(1) The phthalic acid, urea, ceria and ammonium heptamolybdate tetrahydrate were placed in a star ball mill and subjected to a ball-milling mixing according to a weight ratio of 6.5:17.5:6.6:1 (at a rotation speed of 200 rpm for a time of 0.5 h) to obtain a mixture-A;

(2) The mixture-A was placed in a conical flask, and heated to 120° C. in an oil bath pan, followed by heat preservation for 10 min, during which the mixture-A was rapidly stirred until the mixture-A was completely converted from a solid state to a molten state, such that a product-B was obtained;

(3) The product-B was placed in a muffle furnace and the first reaction was carried out at 75° C. for 7 min, followed by natural cooling to room temperature to obtain a block-shaped product-C;

(4) The lump product-C was mixed with graphite oxide powder in a weight ratio of 17:1, the mixture was subsequently placed in a tube furnace to carry out a second reaction at 700° C. and under an argon atmosphere for 20 h, such that the nanographene-a (with an average particle size of 200 nm) was prepared.

Nanographene-b: with a brand No. XFNANO and an average particle size of 220 nm, purchased from Jiangsu XFNANO Materials Tech Co., Ltd.;

Unless otherwise specified, the other materials were commonly used and commercially available products.

### EXAMPLE 1

100 parts by weight of 3# white oil and 2 parts by weight of an emulsifier were taken and mixed at a stirring rate of1,000 r/min for 10 min, 3 parts by weight of an organic clay was then added and blended at a stirring rate of 2,000 r/min for 10 min, 4 parts by weight of a pH regulator was subsequently added and stirred at a stirring rate of 2,000 r/min for 10 min, 15 parts by weight of a calcium chloride aqueous solution was further added and agitated at a stirring rate of 2,000 r/min for 10min, 4 parts by weight of a filtrate reducer was subsequently added and blended at a stirring rate of 2,000 r/min for 20 min, 260 parts by weight of a weighting agent was then added and agitated at a stirring rate of 2,000 r/min for 20 min, 3 parts by weight of a plugging anti-sloughing agent-M1 was further added and blended at a stirring rate of 2,000 r/min for 30 min, 2 parts by weight of a flow pattern regulator was finally added and stirred at a stirring rate of 2,000 r/min for 30 min, an anti-sloughing drilling fluid (denoted as F1) was prepared.

The ingredients of F1 and contents thereof were illustrated in Table 1.

### EXAMPLES 2-3

The anti-sloughing drilling fluids were prepared according to the method in Example 1, except that M2, M3 were respectively used as the plugging anti-sloughing agents, and other conditions are the same as those of Example 1. The anti-sloughing drilling fluids (denoted as F2 and F3, respectively) were prepared.

The ingredients of F2 and F3 and contents thereof were illustrated in Table 1.

### EXAMPLE 4

100 parts by weight of 3# white oil and 8 parts by weight of an emulsifier were taken and mixed at a stirring rate of1,000 r/min for 10 min, 8 parts by weight of an organic clay was then added and blended at a stirring rate of 2,000 r/min for 10 min, 8 parts by weight of a pH regulator was subsequently added and stirred at a stirring rate of 2,000 r/min for 10 min, 25 parts by weight of a calcium chloride aqueous solution was further added and agitated at a stirring rate of 2,000 r/min for 10 min, 10 parts by weight of a filtrate reducer was subsequently added and blended at a stirring rate of 2,000 r/min for 20 min, 290 parts by weight of a weighting agent was then added and agitated at a stirring rate of 2,000 r/min for 20 min, 7 parts by weight of a plugging anti-sloughing agent-M1 was further added and blended at a stirring rate of 2,000 r/min for 30 min, 4 parts by weight of a flow pattern regulator was finally added and stirred at a stirring rate of 2,000 r/min for 30 min, an anti-sloughing drilling fluid (denoted as F4) was prepared.

The ingredients of F4 and contents thereof were illustrated in Table 1.

### EXAMPLES 5-6

The anti-sloughing drilling fluids were prepared according to the method in Example 4, except that M2, M3 were respectively used as the plugging anti-sloughing agents, and other conditions are the same as those of Example 4. The anti-sloughing drilling fluids (denoted as F5 and F6, respectively) were prepared.

The ingredients of F5 and F6 and contents thereof were illustrated in Table 1.

### EXAMPLE 7

100 parts by weight of 3# white oil and 1 parts by weight of an emulsifier were taken and mixed at a stirring rate of1,000 r/min for 10 min, 2 parts by weight of an organic clay was then added and blended at a stirring rate of 2,000 r/min for 10 min, 2 parts by weight of a pH regulator was subsequently added and stirred at a stirring rate of 2,000 r/min for 10 min, 10 parts by weight of a calcium chloride aqueous solution was further added and agitated at a stirring rate of 2,000 r/min for 10 min, 2 parts by weight of a filtrate reducer was subsequently added and blended at a stirring rate of 2,000 r/min for 20 min, 250 parts by weight of a weighting agent was then added and agitated at a stirring rate of 2,000 r/min for 20 min, 1 parts by weight of a plugging anti-sloughing agent-M1 was further added and blended at a stirring rate of 2,000 r/min for 30 min, 1 parts by weight of a flow pattern regulator was finally added and stirred at a stirring rate of 2,000 r/min for 30 min, an anti-sloughing drilling fluid (denoted as F7) was prepared.

The ingredients of F7 and contents thereof were illustrated in Table 1.

### EXAMPLES 8-9

The anti-sloughing drilling fluids were prepared according to the method in Example 7, except that M2, M3 were respectively used as the plugging anti-sloughing agents, and other conditions are the same as those of Example 7. The anti-sloughing drilling fluids (denoted as F8 and F9, respectively) were prepared.

The ingredients of F8 and F9 and contents thereof were illustrated in Table 1.

### EXAMPLE 10

100 parts by weight of 3# white oil and 9 parts by weight of an emulsifier were taken and mixed at a stirring rate of1,000 r/min for 10 min, 9 parts by weight of an organic clay was then added and blended at a stirring rate of 2,000 r/min for 10 min, 9 parts by weight of a pH regulator was subsequently added and stirred at a stirring rate of 2,000 r/min for 10 min, 30 parts by weight of a calcium chloride aqueous solution was further added and agitated at a stirring rate of 2,000 r/min for 10 min, 12 parts by weight of a filtrate reducer was subsequently added and blended at a stirring rate of 2,000 r/min for 20 min, 300 parts by weight of a weighting agent was then added and agitated at a stirring rate of 2,000 r/min for 20 min, 9 parts by weight of a plugging anti-sloughing agent-M1 was further added and blended at a stirring rate of 2,000 r/min for 30 min, 5 parts by weight of a flow pattern regulator was finally added and stirred at a stirring rate of 2,000 r/min for 30 min, an anti-sloughing drilling fluid (denoted as F10) was prepared.

The ingredients of F10 and contents thereof were illustrated in Table 1.

### EXAMPLES 11-14

The anti-sloughing drilling fluids were prepared according to the method in Example 10, except that M2, M3, M4 and M5 were respectively used as the plugging anti-sloughing agents, and other conditions are the same as those of Example 10. The anti-sloughing drilling fluids (denoted as F11, F12, F13 and F14, respectively) were prepared.

The ingredients of F11, F12, F13 and F14 and contents thereof were illustrated in Table 1.

### EXAMPLES 15-16

The anti-sloughing drilling fluids were prepared according to the method in Example 1, except that DM1, DM2 were respectively used as the plugging anti-sloughing agents, and other conditions are the same as those of Example 1. The anti-sloughing drilling fluids (denoted as F15 and F16, respectively) were prepared.

The ingredients of F15 and F16 and contents thereof were illustrated in Table 1.

### Comparative Example 1

The drilling fluid was prepared according to the method in Example 1, except that the plugging anti-sloughing agent-M1 was not added, and other conditions are the same as those of Example 1. The drilling fluid (denoted as DF1) was prepared.

The ingredients of DF1 and contents thereof were illustrated in Table 1.

TABLE 1

| Ingredients, | Examples 1-12 | | | | | | | | | | | |
|---|---|---|---|---|---|---|---|---|---|---|---|---|
| parts by weight | F1 | F2 | F3 | F4 | F5 | F6 | F7 | F8 | F9 | F10 | F11 | F12 |
| 3# White oil | 100 | 100 | 100 | 100 | 100 | 100 | 100 | 100 | 100 | 100 | 100 | 100 |
| Emulsifier | 2 | 2 | 2 | 8 | 8 | 8 | 1 | 1 | 1 | 9 | 9 | 9 |
| Organic clay | 3 | 3 | 3 | 8 | 8 | 8 | 2 | 2 | 2 | 9 | 9 | 9 |
| pH regulator | 4 | 4 | 4 | 8 | 8 | 8 | 2 | 2 | 2 | 9 | 9 | 9 |
| a calcium | 15 | 15 | 15 | 25 | 25 | 25 | 10 | 10 | 10 | 30 | 30 | 30 |
| chloride | | | | | | | | | | | | |
| aqueous | | | | | | | | | | | | |
| solution | | | | | | | | | | | | |
| Filtrate | 4 | 4 | 4 | 10 | 10 | 10 | 2 | 2 | 2 | 12 | 12 | 12 |
| reducer | | | | | | | | | | | | |
| Weighting | 260 | 260 | 260 | 290 | 290 | 290 | 250 | 250 | 250 | 300 | 300 | 300 |
| agent | | | | | | | | | | | | |
| Plugging anti- | 3 | — | — | 7 | — | — | 1 | — | — | 9 | — | — |
| sloughing | | | | | | | | | | | | |
| agent-M1 | | | | | | | | | | | | |
| Plugging anti- | — | 3 | — | — | 7 | — | — | 1 | — | — | 9 | — |
| sloughing | | | | | | | | | | | | |
| agent-M2 | | | | | | | | | | | | |
| Plugging anti- | — | — | 3 | — | — | 7 | — | — | 1 | — | — | 9 |
| sloughing | | | | | | | | | | | | |
| agent-M3 | | | | | | | | | | | | |
| Plugging anti- | — | — | — | — | — | — | — | — | | — | — | — |
| sloughing | | | | | | | | | | | | |
| agen-tM4 | | | | | | | | | | | | |
| Plugging anti- | — | — | — | — | — | — | — | — | — | — | — | — |
| sloughing | | | | | | | | | | | | |
| agent-M5 | | | | | | | | | | | | |
| Plugging anti- | — | — | — | — | — | — | — | — | | — | — | — |
| sloughing | | | | | | | | | | | | |
| agent-DM1 | | | | | | | | | | | | |
| Plugging anti- | — | — | — | — | — | — | — | — | | — | — | — |
| sloughing | | | | | | | | | | | | |
| agent-DM2 | | | | | | | | | | | | |
| Flow pattern | 2 | 2 | 2 | 4 | 4 | 4 | 1 | 1 | 1 | 5 | 5 | 5 |
| regulator | | | | | | | | | | | | |

| | Examples 13-16, | | | | |
|---|---|---|---|---|---|
| Ingredients, | Comparative Example 1 | | | | |
| parts by weight | F13 | F14 | F15 | F16 | DF1 |
| 3# White oil | 100 | 100 | 100 | 100 | 100 |
| Emulsifier | 9 | 9 | 2 | 2 | 2 |
| Organic clay | 9 | 9 | 3 | 3 | 3 |
| pH regulator | 9 | 9 | 4 | 4 | 4 |
| a calcium | 30 | 30 | 15 | 15 | 15 |
| chloride | | | | | |
| aqueous solution | | | | | |
| Filtrate reducer | 12 | 12 | 4 | 4 | 4 |
| Weighting agent | 300 | 300 | 260 | 260 | 260 |
| Plugging anti- | — | — | — | — | — |
| sloughing agent- | | | | | |
| M1 | | | | | |
| Plugging anti- | — | — | — | — | — |
| sloughing agent- | | | | | |
| M2 | | | | | |
| Plugging anti- | — | — | — | — | — |
| sloughing agent- | | | | | |
| M3 | | | | | |
| Plugging anti- | 9 | — | — | — | — |
| sloughing agent- | | | | | |
| M4 | | | | | |
| Plugging anti- | — | 9 | — | — | — |
| sloughing agent- | | | | | |
| M5 | | | | | |
| Plugging anti- | — | — | 3 | — | — |
| sloughing agent- | | | | | |
| DM1 | | | | | |
| Plugging anti- | — | — | — | 3 | — |
| sloughing agent- | | | | | |
| DM2 | | | | | |
| Flow pattern | 5 | 5 | 2 | 2 | — |
| regulator | | | | | |

### Test Examples

The drilling fluids F1-F16 prepared in Examples 1-16 and the drilling fluid DF1 prepared in Comparative Example 1 were subjected to a high-temperature and high-pressure filtrate loss amount test, and the mud cakes obtained after the high-temperature and high-pressure filtrate loss amount test were subjected to the measurements of thickness and lubrication coefficient of mud cakes, the plugging properties of the drilling fluids were evaluated according to the magnitude of the filtrate loss of the drilling fluids and the quality of the formed mud cakes. The results were shown in Table 2.

The high-temperature and high-pressure filtrate loss amount (HTHP, mL) was measured by using a high-temperature and high-pressure filtrate loss meter and according to the method specified in the Chinese National Standard GB/T29170-2012, the test temperature was 120° C., and the pressure differential was 3.5 MPa;

The manufacturer of the high-temperature and high-pressure filtrate loss meter with a model No. GGS71-A was Qingdao Hengtaida Electromechanical Equipment Co., Ltd.;

The lubrication coefficients of mud cakes were measured by using a mud cake viscosity coefficient tester and according to the method specified in the Chinese National Standard GB/T29170-2012;

The manufacture of the mud cake viscosity coefficient tester with a model No. NZ-3A was the Qingdao Senxin Group Co., Ltd.

TABLE 2

| | Thickness | Lubrication | High-temperature |
|---|---|---|---|
| Test | of mud | coefficient of mud | and high-pressure |
| objects | cakes/mm | cakes | filtrate loss amount/mL |
| F1 | 1.5 | 0.0812 | 1.4 |
| F2 | 1.4 | 0.0845 | 2.6 |
| F3 | 1.4 | 0.0849 | 3.0 |
| F4 | 1.6 | 0.0858 | 3.2 |
| F5 | 1.6 | 0.0828 | 3.4 |
| F6 | 1.5 | 0.0850 | 3.6 |
| F7 | 1.4 | 0.0901 | 3.9 |
| F8 | 1.5 | 0.0794 | 4.1 |
| F9 | 1.3 | 0.0877 | 4.2 |
| F10 | 1.4 | 0.0870 | 4.3 |
| F11 | 1.6 | 0.0850 | 4.9 |
| F12 | 1.4 | 0.0877 | 5.4 |
| F13 | 1.5 | 0.0776 | 5.8 |
| F14 | 1.8 | 0.0837 | 5.9 |
| F15 | 2.0 | 0.0837 | 6.8 |
| F16 | 1.4 | 0.0838 | 6.6 |
| DF1 | 2.2 | 0.0849 | 8.2 |

As can be seen from Table 2, the anti-sloughing drilling fluids provided by the present disclosure contain inorganic rigid particles and nanographene which are compounded according to a specific weight ratio and satisfy a specific particle size grading relationship, the drilling fluids exhibit excellent properties of filtrate loss and forming the borehole wall (the high-temperature and high-pressure filtrate loss of F1-F14 is lower than 6mL under the temperature condition of 120° C.) due to the synergistic effect of the ingredients in the drilling fluids, and can form thin and dense mud cakes (the thickness of mud cakes of F1-F14 is less than 1.8 mm), and effectively plug micro-scale and nanometer-level cracks of the stratum, and prevents penetration by the drilling fluid filtrate on the permeable pore and cracks, thereby fulfill the purposes of preventing collapse of horizontal well section and stabilizing the borehole wall. In particular, the compounding ratio of inorganic rigid particles and nanographene in the drilling fluids F15 and F16 does not satisfy the restrictive conditions of the present disclosure, the anti-sloughing effects of the drilling fluids F15 and F16 have a certain distance from those of the drilling fluids F1-F14; the drilling fluid DF1 does not contain a plugging anti-sloughing agent, its plugging anti-sloughing effect is the worst among the drilling fluids.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1. An anti-sloughing drilling fluid comprising the following ingredients: a base oil, an organic clay, an emulsifier, a plugging anti-sloughing agent, a filtrate reducer, an inhibitor, a pH regulator, a weighting agent, and a flow pattern regulator;
wherein the plugging anti-sloughing agent comprises inorganic rigid particles and nanographene; the inorganic rigid particles have an average particle size of 0.6-50 μm, and the nanographene has an average particle size of 30-300 nm.

2. The anti-sloughing drilling fluid of claim 1, wherein the inorganic rigid particles comprise: inorganic rigid particles I, inorganic rigid particles II and inorganic rigid particles III;
wherein the inorganic rigid particles I have an average particle size of 0.6-8 μm, the inorganic rigid particles II have an average particle size of 8-20 μm, and the inorganic rigid particles III have an average particle size of 20-50 μm.

3. The anti-sloughing drilling fluid of claim 2, wherein the inorganic rigid particles I have an average particle size of 1-4 μm, the inorganic rigid particles II have an average particle size of 10-15 μm, and the inorganic rigid particles III have an average particle size of 25-40 μm;
and/or, the nanographene has an average particle size of 60-250 nm.

4. The anti-sloughing drilling fluid of claim 2, wherein a weight ratio of the inorganic rigid particles I:inorganic rigid particles II:inorganic rigid particles III:nanographene is (1.5-4.5):(1.5-4.5):(1.5-4.5):1;
and/or, the inorganic rigid particles I are at least one selected from the group consisting of calcium carbonate, silica and titanium dioxide.
and/or, the inorganic rigid particles II are at least one selected from the group consisting of calcium carbonate, silica and titanium dioxide.
and/or, the inorganic rigid particles III are at least one selected from the group consisting of calcium carbonate, silica and titanium dioxide.

5. The anti-sloughing drilling fluid of claim 4, wherein a weight ratio of the inorganic rigid particles I:inorganic rigid particles II:inorganic rigid particles III:nanographene is (2-4):(2-4):(2-4):1.

6. The anti-sloughing drilling fluid of claim 1, wherein the preparation method of nanographene comprises the following steps:
(1) mixing phthalic acid, urea, ceria and ammonium heptamolybdate tetrahydrate to obtain a mixture-A;
(2) melting the mixture-A to obtain a product-B;
(3) subjecting the product-B to a first reaction to obtain a product-C;
(4) subjecting graphite oxide and the product-C to a second reaction to prepare nanographene.

7. The anti-sloughing drilling fluid of claim 6, wherein a weight ratio of phthalic acid:urea:ceria:ammonium heptamolybdate tetrahydrate in step (1) is (6-7):(16-20):(6-7):1;
and/or, the melting temperature in step (2) is within a range of 110-130° C.;
and/or, the conditions of the first reaction in step (3) comprise: a temperature of 60-90° C.; and a time of 5-10 min;
and/or, a weight ratio of the product-C:graphite oxide in step (4) is (16-18):1;
and/or, the conditions of the second reaction in step (4) comprise: a temperature of 300-800° C.; and a time of 16-24 h.

8. The anti-sloughing drilling fluid of claim 7, wherein a weight ratio of phthalic acid:urea:ceria:ammonium heptamolybdate tetrahydrate in step (1) is (6.3-6.8):(17-18): (6.4-6.8):1;
and/or, the conditions of the first reaction in step (3) comprise: a temperature of 70-80° C.; and a time of 6-8 min;
and/or, the conditions of the second reaction in step (4) comprise: a temperature of 600-800° C.; and a time of 18-24 h.

9. The anti-sloughing drilling fluid of claim 1, wherein the ingredients of the drilling fluid satisfy the following conditions: 2-9 parts by weight of the organic clay, 1-9 parts by weight of the emulsifier, 1-9 parts by weight of the plugging anti-sloughing agent, 2-12 parts by weight of the filtrate reducer, 10-30 parts by weight of the inhibitor, 2-9 parts by weight of the pH regulator, 250-300 parts by weight of the weighting agent, and 1-5 parts by weight of the flow pattern regulator, based on 100 parts by weight of base oil. (Original) The anti-sloughing drilling fluid of claim 9, wherein the ingredients of the drilling fluid satisfy the following conditions: 3-8 parts by weight of the organic clay, 2-8 parts by weight of the emulsifier, 3-7 parts by weight of the plugging anti-sloughing agent, 4-10 parts by weight of the filtrate reducer, 15-25 parts by weight of the inhibitor, 4-8 parts by weight of the pH regulator, 260-290 parts by weight of the weighting agent, and 2-4 parts by weight of the flow pattern regulator, based on 100 parts by weight of base oil.

11. The anti-sloughing drilling fluid of claim 1, wherein the base oil is selected from white oil and/or diesel oil;
and/or, the organic clay is an oleophilic clay produced from an interaction of a hydrophilic bentonite with an alkyl quaternary ammonium salt cationic surfactant;
and/or, the emulsifier is at least one selected from the group consisting of calcium naphthenate, oleic acid, naphthenic acid amides, calcium alkylbenzenesulfonate, and Span series emulsifier;
and/or, the filtrate reducer is at least one selected from the group consisting of oxidized asphalt, sodium carboxymethyl cellulose, humic acid and lignite lye;
and/or, the inhibitor is selected from a calcium chloride aqueous solution and/or a potassium chloride aqueous solution;
and/or, the pH regulator is selected from calcium oxide and/or sodium carbonate;
and/or, the weighting agent is at least one selected from the group consisting of API barite, ultrafine barium sulfate, magnetite powder, ilmenite powder and trimanganese tetroxide;
and/or, the flow pattern regulator is at least one selected from a group consisting of guar gum, xanthan gum and a polymer composed of β-1,4-glycosidically linked glucose monomers. oil;

12. The anti-sloughing drilling fluid of claim 11, wherein the base oil is white oil;
and/or, the filtrate reducer is oxidized asphalt;
and/or, the pH regulator is calcium oxide;
and/or, the weighting agent is API barite.

13. The anti-sloughing drilling fluid of claim 1, wherein the anti-sloughing drilling fluid is subjected to a high-temperature and high-pressure filtrate loss amount test under the conditions consisting of a temperature of 120° C. and a pressure differential of 3.5 MPa, the filtrate loss is less than or equal to 6 mL, a mud cake obtained after the test has a thickness less than or equal to 1.8 mm, and the mud cake has a lubrication coefficient less than or equal to 0.09.

14. A composition comprising the anti-sloughing drilling fluid of claim 1, for use in oil and gas drilling.
